(19) United States
(12) Patent Application Publication
(10) Pub. No.: US 2015/0298063 A1
(43) Pub. Date: Oct. 22, 2015

(54) FLAT REVERSE OSMOSIS MODULE AND SYSTEM

(71) Applicant: GENERAL ELECTRIC COMPANY, Schenectady, NY (US)

(72) Inventors: John Thomas PEICHEL, Minnetonka, MN (US); Philip Paul BEAUCHAMP, Rexford, NY (US); Todd Alan ANDERSON, Niskayuna, NY (US); Dean David MARSCHKE, Minnetonka, MN (US)

(73) Assignee: GENERAL ELECTRIC COMPANY, Schenectady, NY (US)

(21) Appl. No.: 14/651,695

(22) PCT Filed: Dec. 14, 2012
(86) PCT No.: PCT/US12/69786

§ 371 Date: Jun. 12, 2015

(51) Int. Cl. B01D 63/08; B01D 61/02

(52) U.S. Cl. CPC B01D 63/082; B01D 61/025; B01D 61/027; B01D 63/081

(57) ABSTRACT

A filtering module, for example a nanofiltration or reverse osmosis module, is made of membranes arranged in a stack with flat sheets of feed channel spacer and permeate carrier. The stack has packs formed of two membrane sheets sealed on four sides and enclosing a permeate carrier. The packs alternate with sheets of feed channel spacer through the thickness of the stack. One or more permeate-collecting pipes pass through the thickness of the stack. The sheets of feed channel spacer have seals along two sides and around the permeate-collecting pipes. A module is formed by placing one or more stacks in a pressure vessel with a seal between the stack and the pressure vessel at a downstream end of the stack.

### FIELD

This specification relates to membrane filtration modules, for example reverse osmosis modules, and to methods of making them.

### BACKGROUND

Flat sheet membranes have been used in immersed ultrafiltration or microfiltration modules. In modules produced by Kubota, membrane sheets are provided on both sides of a plastic frame to form a hollow pocket. The pockets are placed in a spaced apart arrangement in a module and immersed in an open tank. Permeate is withdrawn by suction applied through a port in the frame to the inside of the pocket. In a module described in U.S. Pat. No. 7,892,430, filter elements are made up of two membrane sheets provided on both sides of a drainage element. The elements are arranged in a spaced apart relationship and immersed in an open tank. Permeate is withdrawn by suction through a pipe that passes through bores in the elements. Operating immersed in a tank of feed water and at low transmembrane pressure differential avoids the need for these modules to be rigid or strong.

Flat sheet membranes have also been used in reverse osmosis. However, reverse osmosis membranes are typically formed into spiral wound modules. The spiral wound configuration is inherently suited to high pressure applications when there is no cross flow on the permeate side. Attempts to make flat sheet pressure driven modules, some with cross flow, are described in U.S. Pat. No. 5,104,532, U.S. Pat. No. 5,681,464, U.S. Pat. No. 6,524,478, European Patent 1355730 and Japanese publication 7068137.

### BRIEF DESCRIPTION OF THE INVENTION

The following section is intended to introduce the reader to the detailed description to follow and not to limit or define the claims.

This specification describes a filtering module comprising flat sheet membranes. The membranes are arranged in a stack with flat sheets of feed channel spacer and permeate carrier. The stack has packs formed of two membrane sheets sealed on four sides and enclosing a permeate carrier. The packs alternate with sheets of feed channel spacer through the thickness of the stack. One or more permeate-collecting pipes communicate with the permeate carrier, for example by passing through the thickness of the stack. The sheets of feed channel spacer have seals along two sides and around the permeate-collecting pipes. Optionally the feed spacer seals are made by pre-injecting a thermoplastic material into a feed spacer and allowing the thermoplastic material to solidify before the stack is assembled. A module is formed by placing one or more stacks in a pressure vessel. A seal between the stack and the pressure vessel located at a downstream end of the stack separates the pressure vessel into feed and concentrate compartments. Multiple modules may be connected in series or parallel arrangements.

### BRIEF DESCRIPTION OF THE DRAWINGS

FIG. 1 is an exploded isometric view of an assembly of sheets forming a permeate pack.

FIG. 2 is a plan view of a permeate pack.

FIG. 3 is a plan view of a feed spacer.

FIG. 4 is a cross-section of a stack comprising permeate packs and feed spacers.

FIG. 5 is a side view of a membrane module.

FIG. 6 is an end view of a set of membrane modules connected in parallel.

### DETAILED DESCRIPTION

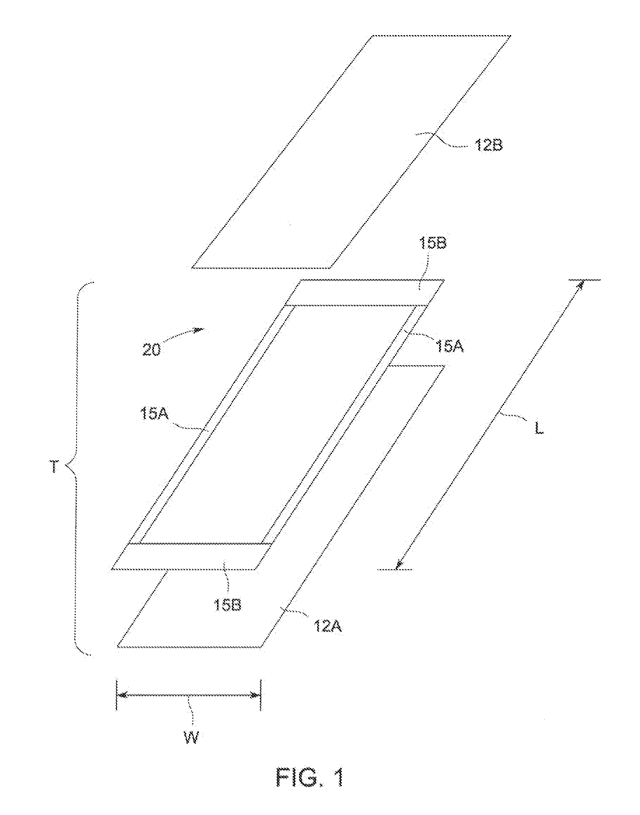

FIG. 1 shows a sub-assembly comprising layers of flat sheet materials. The sub-assembly may alternatively be called a permeate pack 20 or packet in this specification. The individual layers of the permeate pack 20 are: first membrane 12a, permeate carrier 16, and second membrane 12b. Optionally, the first membrane 12a and the second membrane 12b may be provided by a single sheet of material folded, along its length according to an embodiment, around the permeate carrier 16. The separation layers of the membranes 12 face away from the permeate carrier 16. Optionally, other forms of permeate packs 20 may be made wherein a permeate carrier is sealed within an envelope comprising a filtering membrane.

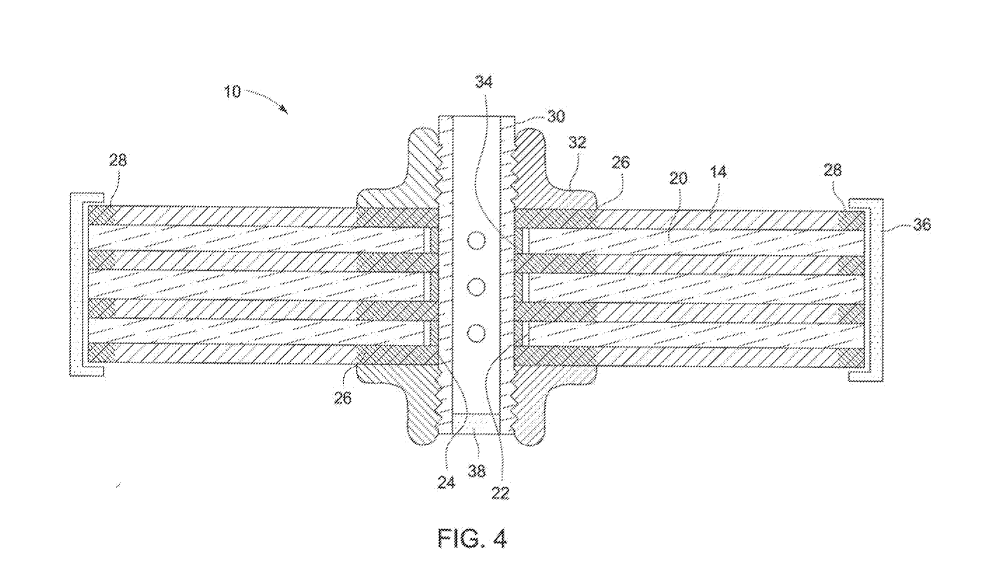

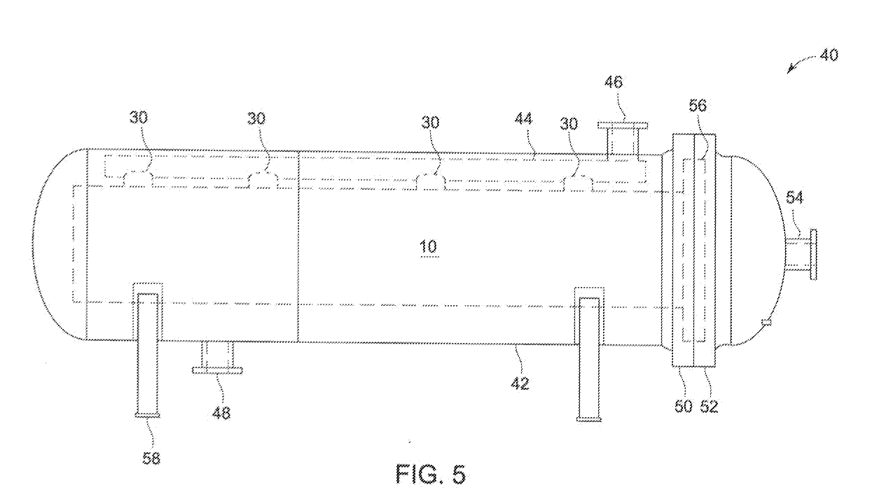

Referring to FIG. 4, a stack 10 is formed by placing multiple permeate packs 20 in a stack with feed spacers 14 between the permeate packs 20. In an embodiment, a feed spacer 14 is also placed at the bottom and at the top of the stack 10. The permeate packs 20 and feed spacers 14 are generally rectangular according to an embodiment. The permeate packs 20 and feed spacers 14 are generally flat, or planar, in the stack 10 according to an embodiment.

For the purposes of this specification, the stack 10 will be described with reference dimensions as shown in FIG. 1. The longer dimension of the sheets of material will be referred to as a length L. The shorter dimension of the sheets of material will be referred to as the width W. The dimension perpendicular to the sheets of material will be referred to as thickness T. The length L of the stack 10 is, in an embodiment, two or more, or three or more, times the width W of the stack. The length L is, in an embodiment, 2 m or more, or 3 m or more. This is longer than a typical spiral wound membrane and reduces the amount of membrane material occupied by seals and interconnectors per unit length. Because the stack 10 is formed of flat materials, the width of seals also does not need to account for movement of the materials during rolling or significant material removed in length trimming as is typically the case with spiral wound modules.

The sheets of material in the stack 10 may be the same materials used in making spiral wound membranes. For example, the membrane 12 may be a thin film composite reverse osmosis or nanofiltration membrane cast on a supporting structure. The feed spacer 14 may be an expanded plastic mesh. The permeate carrier 16 may be a tricot knit fabric.

Referring back to FIG. 1, seals 15 are provided between the membranes 12 of a permeate pack 20. The seals 15 are provided around the perimeter of the permeate pack 20. In the example of FIG. 1, seals 15 are shown on the permeate carrier 16. This is in accordance with a seal made by applying an adhesive to the permeate carrier 16. However, when a permeate pack 20 as shown in FIG. 1 is assembled and compressed, the adhesive penetrates through the permeate carrier 16 and attached to the first membrane 12a and the second membrane 12b. A similar seal 15 may be formed by applying an adhesive along the edges of the first membrane 12a or the second membrane 12b.

Seals 15 may be made by any method known for making a spiral wound membrane. For example, as described above, a seal 15 may be a fold in a membrane 12 or made by an adhesive. Suitable adhesives include urethanes, epoxies, silicones, acrylates and hot melt adhesives. However, unlike spiral wound membranes modules, the stack 10 may be assembled in some methods without requiring sheets of material to slide against each other while an adhesive is curing. Accordingly, adhesives may be chosen that are less viscous or quicker setting. A seal may also be made with an essentially instant bond, for example by melting, laser welding or ultrasonic welding. Alternatively, a seal may be made by a line of tape joining two successive membranes 12 together around a permeate carrier 16.

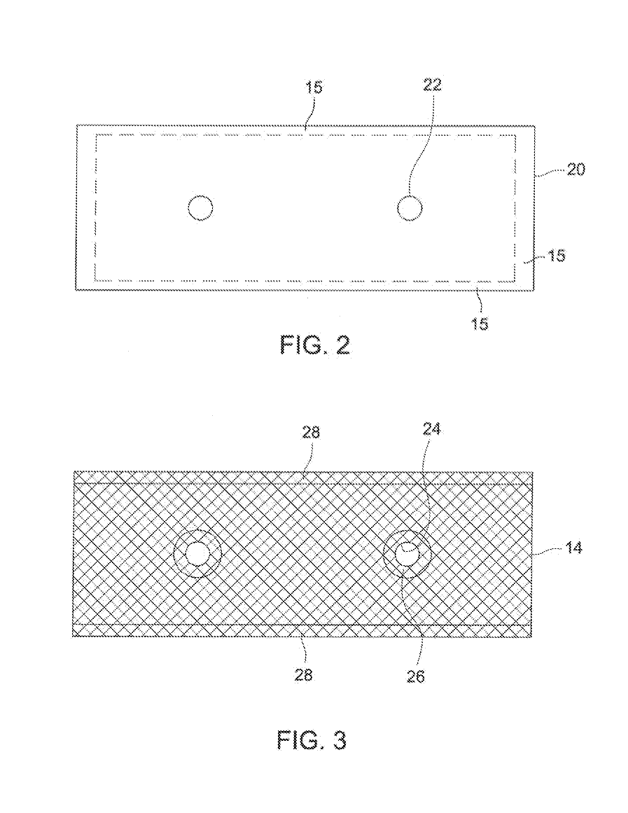

Referring to FIG. 2, a permeate pack 20 has one or more permeate holes 22. Referring to FIG. 3, a feed spacer 14 has one or more feed holes 24. The permeate holes 22 and feed spacer holes 24 are located such that, when permeate packs 20 and feed spacers 14 are assembled into the stack, they form one or more continuous vertical passage through the stack 10. The permeate holes 22 may be made by punching them out of the permeate pack 20 with a die. The feed spacer holes 24 may be made by punching them out of a feed spacer 14 before or after casting a disc seal 26 into the feed spacer 14. Optionally, the permeate holes 22 and feed spacer holes 24 may be formed after a stack is assembled, for example by passing a drill, hole cutter, or punch through the stack 10.

The disc seal 26 may be made, for example, by applying molten hot melt adhesive to the feed spacer 14 and then compressing the hot melt adhesive, optionally while still heating it, until a disc is formed at about the same thickness as the feed spacer 14 and embedded in the feed spacer 14. The hot melt adhesive may be allowed to solidify before forming a stack 10. Optionally, the hot melt adhesive can be used in the manner of a gasket by compressing it in the stack 10 without re-heating it. The feed spacer 14 also has edge barriers 28 along both long edges of the feed spacer 14. The edge barriers 28 may be made from hot melt adhesive applied and compressed into the feed spacer 14 as described for the disc seals 26. Alternatively, the edge barrier 28 and disc seals 26 may be made of pieces of material, for example an elastomeric or thermoplastic material, that are separate from the feed spacer 14 but about the same thickness as the feed spacer 14. These separate pieces of material may be compressed in the manner of a gasket, or heated, or otherwise activated, to form seals in the stack 10.

In a stack 10, feed water to be filtered enters the stack 10 by flowing into one of the open ends of the feed spacers 14. Retentate, alternatively called concentrate or brine, exits from the other end of the feed spacers 14. The feed water is diverted around the feed spacer holes 24 by the disc seals 26. Some of the feed water passes through the membranes 12 as permeate. The permeate passes through the permeate carrier 16 to the permeate holes 22.

Referring to FIG. 4, a stack 10 comprises a set of permeate packs 20 with feed spacers 14 between them. The permeate holes 22 and feed spacer holes 24 are generally aligned vertically. One or more permeate conduits, such as permeate pipes 30, pass through the permeate holes 22 and the feed spacer holes 24. Optionally, a permeate conduit may have a non-tubular shape. Optionally, one end of a permeate pipe 30 may have a plug 38. The permeate pipe 30 has openings through its sides within the thickness of the stack 10. Abutments connected to the permeate pipe, such as nuts 32 threaded onto the permeate pipe 30, compress the stack 10 in the area of the permeate pipe 30. Optionally, porous spacer rings 34 may be inserted inside the permeate holes 22 to avoid crushing the permeate packs 20. Optionally, one of the nuts 32 may be replaced with a fixed abutment. Alternatively, other means may be used to attach a permeate pipe 30 to the stack 10 but the nuts 32 allow the stack to be compressed around the permeate pipe 30 while still allowing the permeate pipe 30 to be removed, for example to dis-assemble the stack 10.

When compressed, the disc seals 26 seal against the permeate packs 20 above and below them. The stack 10 also has clamps 36 along its length. The clamps 36 compress the edge barriers 28 against the permeate packs 20. The clamps 36, in an embodiment, comprises upper and lower jaws that are compressed together, for example by screws passing between them, in a manner that permits them to be removed, for example to dis-assemble the stack 10. Optionally, the stack 10 may be re-heated to melt the disc seals 26 and edge barriers 28 so that they adhere to the permeate packs 20. Optionally, the disc seals 26 and edge barriers 28 may be made by applying a liquid adhesive to the feed spacers 14 or separate pieces of material associated with the feed spacers 14, assembling the stack 10 with the adhesive still in a liquid state, and solidifying the liquid adhesive after assembling the stack 10. In a further alternative the disc seals 26 and edge barriers 28 may be made of a hot melt adhesive that is solid when the stack 10 is assembled, but then re-melted and re-solidified after the stack 10 is assembled to adhere to the permeate packs 20. However, forming seals by merely compressing the sealant discs 20 and edge barriers 28 creates a stack 10 that may be disassembled for inspection or repair. Optionally, the clamps 36 may function as the edge barriers 28 and edge barriers between the packets 20 may be omitted. Optionally, different methods of construction and assembly may be used for the disc seals 26 and the edge barriers 28.

FIG. 5 shows a membrane module 40, alternatively called an element. The module 40 has a shell 42 containing a stack 10. The stack 10 has a plurality of permeate pipes 30 spaced along its length. The permeate pipes 30 are connected to a permeate collector 44 located inside of the shell 42. The permeate collector 44 is connected to a permeate port 46 on the shell 42. Feed water enters the module 40 through a feed port 48 on the shell 42. One end of the shell 42 has a flange 50. A removable cap 52 can be bolted to the flange 50 to enclose the stack 10 in the shell 42. The flange 50 and cap 52 are configured to compress and seal against a baffle 56 attached and sealed to the outside of one end of the stack 10. In this way, a feed side of the module 40 to the left of the baffle 56 is separated from a concentrate side of the module 40 to the right of the baffle 56. The baffle 56 prevents feed water from bypassing the inside of the stack 10. The cap 52 can be removed if required to remove the stack 10 for inspection or maintenance. The other end of the shell 42, opposite the flange 50, may be permanently closed. This avoids having to provide a seal at this end of the shell 42.

In operation, feed water enters the module 40 through the feed port 48, flows into a first end of the stack 10, and flows along the feed spacers 14 to the baffle 56. The edge barriers 28 cause the feed water to flow generally along the length of the stack 10 while inside the stack 10. Some of the feed water permeates into the permeate packs 20 and leaves the module through one or more permeate ports 46. The remainder of the feed water passes through the baffle 56 and exits from a second end of the stack 10 into the cap 52. Concentrate is withdrawn from the cap 52 through a concentrate port 54.

The pressure of the feed water in the feed spacers 14 decreases towards the baffle 56. In contrast, the feed water remains essentially at the applied pressure inside the shell 42 but outside of the stack 10. The feed water pressure therefore helps prevent the stack 10 from expanding between the clamps 36 and the permeate pipes 30. This keeps the permeate packs 20 compressed against the feed spacers 14 which helps ensure that the feed water is made turbulent by the feed spacers 14 to inhibit concentration polarization at the surface of the membranes 12. In this way, feed water pressure is used to keep the stack 10 in compression to help minimize the gap between permeate packs 20 on either side of a feed spacer 14. This promotes effective feed flow mixing to help reduce concentration polarization and increase salt removal by the permeate packs 20.

The module 40 may optionally have stands 58 attached to the shell 42 to allow the module 40 to be freestanding. Alternatively, one or more modules 40 may be held in racks. The shell 42 is, in an embodiment, cylindrical to help resist pressure with an efficient use of material but other shapes may alternatively be used. A shell 42 may contain multiple modules 40 in line. In this case, modules 40 located other than at the cap 52 have baffles 56 that are fitted around the stack 10 and extent to the inside of the shell 42 such that feed water must flow through the modules 40 in a shell 42 in series.

The feed port 48 is, in an embodiment, located on the bottom of the shell 42 from the bottom. This helps avoid air entrapment in a feedwater pipe connected to the feed port 48. The feedwater pipe typically has a large diameter. As water enters the shell 42 through the feed port 48, air rises from the feedwater pipe into the shell 42 and collects at the top of the shell 42. The collected air is periodically released through an air release valve 47 at the top of the shell 42.

The permeate port 46 is, in an embodiment, located at the top of the shell 42. This helps remove air on the permeate side of the module 40. Having multiple permeate pipes 30 reduces the average distance that permeate must travel through permeate carrier 16 and so increases the net driving pressure. However, the permeate collector 44 avoids having as many permeate ports 46 as permeate pipes 30.

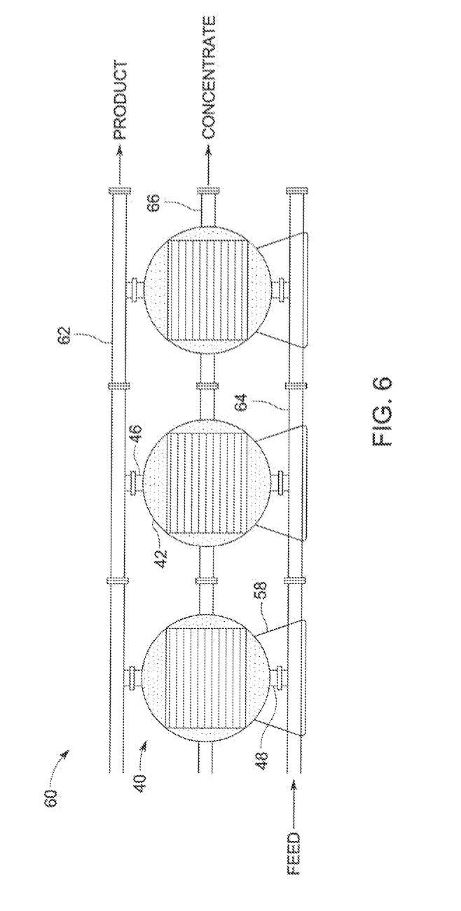

FIG. 6 shows a system 60 comprising a set of modules 40. The left side of the modules 40 as shown in FIG. 5 is visible in FIG. 6. The permeate ports 46 are connected to a permeate pipe 62. The feed ports 48 are connected to a feed pipe 64. The concentrate ports 54 (not visible) are connected to a concentrate pipe 66. As shown in FIG. 6, the permeate pipe 62, the feed pipe 64 and the concentrate pipe 66 may be made in segments of generally equal length with flanges or other features adapted for end to end connections.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

We claim:

1. A filtration module, comprising:
a stack comprising:
a plurality of packets;
a plurality of feed spacer sheets;
one or more permeate conduits; and,
a plurality of edge barriers,
wherein:
the packets comprise a permeate carrier sealed inside of an envelope comprising a reverse osmosis or nanofiltration membrane,
the packets and feed spacer sheets are generally planar and stacked in a direction perpendicular to their planes,
the stack is generally in the shape of a rectangular parallelpiped having two long sides perpendicular to the planes of the packets and feed spacer sheets, a first end and a second end,
the permeate pipes are in fluid communication with the permeate carriers but prevented from having fluid communication with the feed spacer sheets, and,
the edge barriers define passages along the length of the stack within the feed spacer sheets;
a shell comprising a feed port, a concentrate port, and one or more permeate ports, wherein the shell surrounds the stack, and wherein the one or more permeate ports are in fluid communication with the one or more permeate conduits; and,
a baffle located at a first end of the stack and extending between the outside of the stack and the inside of the shell, the baffle substantially preventing fluid communication within the shell between the feed port and the concentrate port except through the stack, the feed port being in fluid communication with the second end of the stack.

2. The filtration module of claim 1, wherein the one or more permeate ports are located at the top of the shell.

3. The filtration module of claim 1, further comprising a permeate collector within the shell and connected between multiple permeate conduits and a single permeate port.

4. The filtration module of claim 1, wherein the feed port is located at the bottom of the shell.

5. The filtration module of claim 1, further comprising a plurality of stacks inside a single shell.

6. The filtration module of claim 1, wherein the stack can be selectively dis-assembled.

7. The filtration module of claim 1, wherein the shell further comprises a removable cap at one end and is closed at the other end.

8. The filtration module of claim 7, wherein the concentrate port is on the same side of the baffle as the cap.

9. A filtration device, comprising,
a stack comprising,
a plurality of generally planar and generally rectangular packets, each packet comprising a permeate carrier located between two membrane sheets sealed together around the perimeter of the packet, each packet having one or more permeate holes within the perimeter of the packet;
a plurality of feed spacer sheets, each feed spacer sheet having one or more feed spacer holes, a feed spacer sheet located between each pair of adjacent packets;
edge barriers along long sides of the feed spacer sheets; and,
disc seals around the feed spacer holes,
wherein the packets and feed spacer sheets are stacked in a direction perpendicular to the packets and the permeate holes and feed spacer holes form one or more holes through stack within the perimeter of the stack; and,
one or more permeate pipes located in the one or more holes though the stack.

10. The filtration device of claim 9, further comprising a nut threaded to each permeate pipe and compressing a part of the stack adjacent to the hole through the stack containing the permeate tube.

11. The filtration device of claim 9, further comprising edge clamps compressing a part of the stack containing the edge barriers.

12. The filtration device of claim 9, further comprising a shell containing the stack.

13.-21. (canceled)

22. A method of making a filtration device, the method comprising:
assembling a plurality of generally flat packets wherein in each packet a permeate carrier is sealed inside of an envelope comprising a membrane;
providing a plurality of feed spacer sheets, each feed spacer sheet having two edge barriers on opposing sides of the feed spacer sheets and a ring seal between the edge barriers;
stacking the packets and feed spacer sheets in a direction perpendicular to their planes;
forming holes in the packets and in the feed spacer sheets within the ring seals before or after forming the stack such that a continuous hole is provided through the stack; and,
passing a porous tube through the hole.

23. The method of claim 22, further comprising compressing, melting, or applying an adhesive to the edge barriers or ring seals.

24. The method of claim 22, further comprising compressing edges of the stack comprising the edge barriers.

25. The method of claim 22, wherein the packets are pre-assembled before step stacking the packets and feed spacer sheets.

26. The method of claim 22, the edge barriers and ring seals are attached to the feed spacer sheets before stacking the packets and feed spacer sheets.

27. The method of claim 22, wherein providing a plurality of feed spacer sheets comprises applying hot melt adhesive to the plurality of flat feed spacer sheets to form on each feed spacer sheet two embedded solid edge barriers on opposing sides of the feed spacer sheets and a ring seal between the edge barriers.

28. The method of claim 22, wherein in stacking the packets and feed spacer sheets the edge barriers of the feed spacer sheets are aligned to be parallel with each other and with long sides of the packets.

29. The method of claim 22, further comprising compressing the stack between two abutments attached to the porous tube.

30. (canceled)
